(19) United States
(12) Patent Application Publication
(10) Pub. No.: US 2025/0192463 A1
(43) Pub. Date: Jun. 12, 2025

(54) TERMINAL UNIT AND FIRST TERMINAL

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yuta KANEMATSU, Mie (JP); Sunghyun BYUN, Mie (JP); Nobukazu HIROWAKI, Mie (JP)

(21) Appl. No.: 18/843,709

(22) PCT Filed: Mar. 3, 2023
(86) PCT No.: PCT/JP2023/008017

§ 371 Date: Sep. 4, 2024

(30) Foreign Application Priority Data
Mar. 11, 2022 (JP) 2022-037746

(51) Int. Cl. H01R 13/11; H01R 13/03; H01R 13/04

(52) U.S. Cl. CPC H01R 13/111; H01R 13/03; H01R 13/04

(57) ABSTRACT

A terminal unit includes a first terminal including a columnar connecting portion, a first side contact point provided on the columnar connecting portion and a sliding resistance reducing portion extending from a tip surface of the columnar connecting portion toward the first side contact point, and a second terminal including a tubular connecting portion and a second side contact point provided on the tubular connecting portion. The columnar connecting portion is assembled with the tubular connecting portion by being press-fit into the tubular connecting portion. The sliding resistance reducing portion avoids direct sliding contact between the outer peripheral surface of the columnar connecting portion and the second side contact point to reduce sliding resistance of the columnar connecting portion against the second side contact point until the sliding resistance reducing portion moves beyond the second side contact point in a press-fitting direction.

### TECHNICAL FIELD

The present disclosure relates to a terminal unit and a first terminal.

### BACKGROUND

Patent Document 1 discloses a terminal unit realizing an electrically connection structure by a male terminal (first terminal) including a columnar connecting portion called a pin terminal or the like and a female terminal (second terminal) including a tubular connecting portion called a sleeve terminal or the like. A resilient contact piece folded rearward from a tip opening is provided inside the tubular connecting portion of the second terminal. If the columnar connecting portion of the first terminal is inserted through the tip opening of the tubular connecting portion of the second terminal, the resilient contact piece contacted by the columnar connecting portion is expanded in diameter and deformed against a resilient restoring force and the columnar connecting portion is allowed to enter the inside of the tubular connecting portion. By this resilient restoring force of the resilient contact piece, a contact point portion provided on an end part of the resilient contact piece is pressed against the columnar connecting portion of the first terminal and the first terminal and second terminal are held in contact and electrically connected.

### PRIOR ART DOCUMENT

### Patent Document

Patent Document 1: JP 2016-024901 A

### SUMMARY OF THE INVENTION

### Problems to be Solved

In such a terminal unit of a conventional structure, the resilient contact piece of the tubular connecting portion moves while rubbing against a surface of the columnar connecting portion in press-fitting the columnar connecting portion of the first terminal into the tubular connecting portion of the second terminal. Thus, plating on the columnar connecting portion and the tubular connecting portion is scraped by repeated insertion and withdrawal of the first terminal into and from the second terminal, which may lead to troubles such as an increase in contact resistance.

Accordingly, novel terminal unit and first terminal are disclosed which can suppress the scraping of plating on a columnar connecting portion and a tubular connecting portion.

### Means to Solve the Problem

A terminal unit of the present disclosure is provided with a first terminal including a columnar connecting portion, a first side contact point provided on an outer peripheral surface of the columnar connecting portion and a sliding resistance reducing portion extending from a tip surface of the columnar connecting portion toward the first side contact point, and a second terminal including a tubular connecting portion resiliently deformable in a diameter expanding direction and a second side contact point provided on an inner peripheral surface of the tubular connecting portion, the columnar connecting portion being assembled with the tubular connecting portion by being press-fit into the tubular connecting portion with the tip surface in the lead, the sliding resistance reducing portion avoids direct sliding contact between the outer peripheral surface of the columnar connecting portion and the second side contact point to reduce sliding resistance of the columnar connecting portion against the second side contact point until the sliding resistance reducing portion moves beyond the second side contact point in a press-fitting direction of the columnar connecting portion into the tubular connecting portion, and the first side contact point being pressed into contact with the second side contact point after the sliding resistance reducing portion moves beyond the second side contact point.

A first terminal of the present disclosure is a first terminal to be assembled with a second terminal including a tubular connecting portion resiliently deformable in a diameter expanding direction and a second side contact point provided on an inner peripheral surface of the tubular connecting portion, the first terminal constituting the terminal unit of the present disclosure.

### Effect of the Invention

According to the present disclosure, the scaping of plating on a columnar connecting portion and a tubular connecting portion can be suppressed.

### BRIEF DESCRIPTION OF THE DRAWINGS

FIG. 1 is a perspective view of a terminal unit according to a first embodiment showing a connected state of a first terminal and a second terminal.

FIG. 2 is a perspective view of the terminal unit shown in FIG. 1 showing a non-connected state of the first and second terminals.

FIG. 3 is a section along III-III in FIG. 4 of the terminal unit shown in FIG. 1.

FIG. 4 is a section along IV-IV in FIG. 3 of the terminal unit shown in FIG. 1.

FIG. 5 is a perspective view showing the first terminal constituting the terminal unit shown in FIG. 1.

FIG. 6 is a perspective view showing a first terminal fitting constituting the first terminal shown in FIG. 5.

FIG. 7A is a diagram showing a model state in press-fitting the first terminal into the second terminal, wherein a state when the first terminal starts to be press-fit into the second terminal is shown by a cross-section corresponding to a cross-section along VIIA-VIIA in FIG. 3.

FIG. 7B is a diagram showing a state where the first terminal is further press-fit from the state of FIG. 7A.

FIG. 7C is a diagram showing a state where the first terminal is further press-fit from the state of FIG. 7B.

FIG. 7D is a diagram showing a state where the first terminal is further press-fit from the state of FIG. 7C, wherein the first and second terminals are fit.

FIG. 8 is a section, corresponding to FIG. 4, showing a terminal unit according to a second embodiment.

FIG. 9 is a perspective view showing a first terminal constituting the terminal unit shown in FIG. 8.

FIG. 10 is a perspective view showing a first terminal fitting constituting the first terminal shown in FIG. 9.

FIG. 11A is a diagram, corresponding to FIG. 7A, showing a model state in press-fitting the first terminal into a second terminal.

FIG. 11B is a diagram showing a state where the first terminal is further press-fit from the state of FIG. 11A.

FIG. 11C is a diagram showing a state where the first terminal is further press-fit from the state of FIG. 11B.

FIG. 11D is a diagram showing a state where the first terminal is further press-fit from the state of FIG. 11C, wherein the first and second terminals are fit.

### DETAILED DESCRIPTION TO EXECUTE THE INVENTION

### Description of Embodiments of Present Disclosure

First, embodiments of the present disclosure are listed and described.
(1) The terminal unit of the present disclosure is provided with a first terminal including a columnar connecting portion, a first side contact point provided on an outer peripheral surface of the columnar connecting portion and a sliding resistance reducing portion extending from a tip surface of the columnar connecting portion toward the first side contact point, and a second terminal including a tubular connecting portion resiliently deformable in a diameter expanding direction and a second side contact point provided on an inner peripheral surface of the tubular connecting portion, the columnar connecting portion being assembled with the tubular connecting portion by being press-fit into the tubular connecting portion with the tip surface in the lead, the sliding resistance reducing portion avoids direct sliding contact between the outer peripheral surface of the columnar connecting portion and the second side contact point to reduce sliding resistance of the columnar connecting portion against the second side contact point until the sliding resistance reducing portion moves beyond the second side contact point in a press-fitting direction of the columnar connecting portion into the tubular connecting portion, and the first side contact point being pressed into contact with the second side contact point after the sliding resistance reducing portion moves beyond the second side contact point.

According to the terminal unit of this structure, the columnar connecting portion of the first terminal includes the sliding resistance reducing portion extending from the tip surface toward the first side contact point provided on the outer peripheral surface of the columnar connecting portion, the sliding resistance reducing portion reduces the sliding resistance of the columnar connecting portion against the second side contact point by avoiding direct sliding contact between the outer peripheral surface of the columnar connecting portion and the second side contact point until the sliding resistance reducing portion moves beyond the second side contact point in the press-fitting direction of the columnar connecting portion into the tubular connecting portion, and the first side contact point is pressed into contact with the second side contact point after the sliding resistance reducing portion moves beyond the second side contact point. In this way, a risk of plating scraping of the second side contact point due to the direct sliding contact of the outer peripheral surface of the columnar connecting portion with the second side contact point until the first side contact point reaches the second side contact point in press-fitting the columnar connecting portion into the tubular connecting portion can be reduced or prevented. As a result, the occurrence of troubles such as an increase in contact resistance between the first and second contact points can be suppressed. Further, since the sliding resistance reducing portion avoids direct sliding contact between the outer peripheral surface of the columnar connecting portion and the second side contact point until the sliding resistance reducing portion moves beyond the second side contact point from an initial stage of press-fitting of the columnar connecting portion into the tubular connecting portion, troubles such as plating scraping of the second side contact point can be reduced or prevented while insertion resistance of the columnar connecting portion (first terminal) into the tubular connecting portion (second terminal) is reduced.

Note that any configuration can be adopted if the sliding resistance reducing portion reduces sliding resistance by avoiding direct sliding contact between the outer peripheral surface of the columnar connecting portion and the second side contact point until the sliding resistance reducing portion moves beyond the second side contact point in the press-fitting direction.

Further, the columnar connecting portion can have any shape as long as having a columnar projecting shape. For example, a solid cylindrical shape and a hollow cylindrical shape can be both adopted.
(2) Preferably, a region from the tip surface to the first side contact point has a separated facing surface located radially inward to face the second side contact point across a gap in a radial direction in a circumferential region of the columnar connecting portion overlapping the second side contact point in the press-fitting direction when the columnar connecting portion is concentrically arranged in being press-fit into the tubular connecting portion, and the sliding resistance reducing portion is formed by the separated facing surface. By providing the separated facing surface located radially inward and facing the second side contact point across the gap in the radial direction in the predetermined circumferential region of the columnar connecting portion, the sliding resistance reducing portion can be easily formed. Particularly, since the separated facing surface serving as the sliding resistance reducing portion is formed to face the second side contact point across the gap in the radial direction, a trouble of plating scraping due to the direct sliding of the outer peripheral surface of the columnar connecting portion against the second side contact point until the first side contact point reaches the second side contact point can be more reliably reduced or avoided.
(3) Preferably, the region from the tip surface to the first side contact point has a resin outer peripheral surface made of a synthetic resin material in the circumferential region of the columnar connecting portion overlapping the second side contact point in the press-fitting direction when the columnar connecting portion is concentrically arranged in being press-fit into the tubular connecting portion, and the sliding resistance reducing portion is formed by the resin outer peripheral surface. Since the sliding resistance reducing portion is provided by forming the outer peripheral surface of the columnar connecting portion in contact with the second side contact point by the resin outer peripheral surface in the predetermined circumferential region of the columnar connecting portion, i.e. until the first side contact point reaches the second side contact point, a trouble of plating scraping due to the direct sliding of the outer peripheral surface of the columnar connecting portion against the second side contact point until the first side contact point reaches the second side contact point can be advantageously reduced or avoided. Particularly, by adopting the mode of (2) described above in combination, the sliding resistance of the resin outer peripheral surface against the second side contact point can be further reduced and it is possible both to reduce the plating scraping of the second side contact point and reduce press-fitting resistance of the columnar connecting portion into the tubular connecting portion.
(4) Preferably, a resin cap is provided which covers the tip surface of the columnar connecting portion, and the resin outer peripheral surface is integrally provided to the resin cap. This is because the number of components can be reduced and handleability and assemblability can be improved by integrally providing the resin cap, which is a resin member to be mounted on the columnar connecting portion, and the resin outer peripheral surface. Further, by covering the tip surface with the resin cap, a measure against electric shock caused by wrong finger touch.
(5) Preferably, a contact surface of the resin outer peripheral surface with the columnar connecting portion includes an engaging hole to be engaged with a projection provided on the columnar connecting portion, and the resin outer peripheral surface is held on the columnar connecting portion by fitting the projection into the engaging hole. This is because the resin outer peripheral surface can be stably held on the columnar connecting portion by a fitting force of the engaging hole and the projection even if sliding resistance is applied to the resin outer peripheral surface. Moreover, since the engaging hole and the projection are provided between the resin outer peripheral surface and the facing surface of the columnar connecting portion, the retention of the resin outer peripheral surface can be improved without being accompanied by enlargement.
(6) Preferably, a first housing is further provided which accommodates the first terminal, the first housing includes a tubular cover portion separated and arranged radially outwardly of the columnar connecting portion, the tubular cover portion includes a pair of cut portions provided at two positions facing each other in a radial direction of the tubular cover portion, and the columnar connecting portion of the first terminal is positioned in a circumferential direction in the tubular connecting portion of the second terminal by inserting and arranging the second terminal in the pair of cut portions. Since the columnar connecting portion and the tubular connecting portion are positioned in the circumferential direction by inserting the second terminal into the pair of cut portions provided in the tubular cover portion of the first housing, it is possible to prevent a trouble of press-fitting the columnar connecting portion in a wrong circumferential orientation and causing plating scraping due to the sliding of the second side contact point of the tubular connecting portion against the metal-made outer peripheral surface of the columnar connecting portion.

The first terminal of the present disclosure is a first terminal to be assembled with a second terminal including a tubular connecting portion resiliently deformable in a diameter expanding direction and a second side contact point provided on an inner peripheral surface of the tubular connecting portion, the first terminal constituting the terminal unit of any one of (1) to (6) described above.

According to this aspect, it is possible to provide the first terminal capable of similarly enjoying functions and effects described in (1) to (6).

### Details of Embodiments of Present Disclosure

Specific examples of a terminal unit and a first terminal of the present disclosure are described below with reference to the drawings. Note that the present disclosure is not limited to these illustrations, but is represented by claims and intended to include all changes in the scope of claims and in the meaning and scope of equivalents.

### First Embodiment

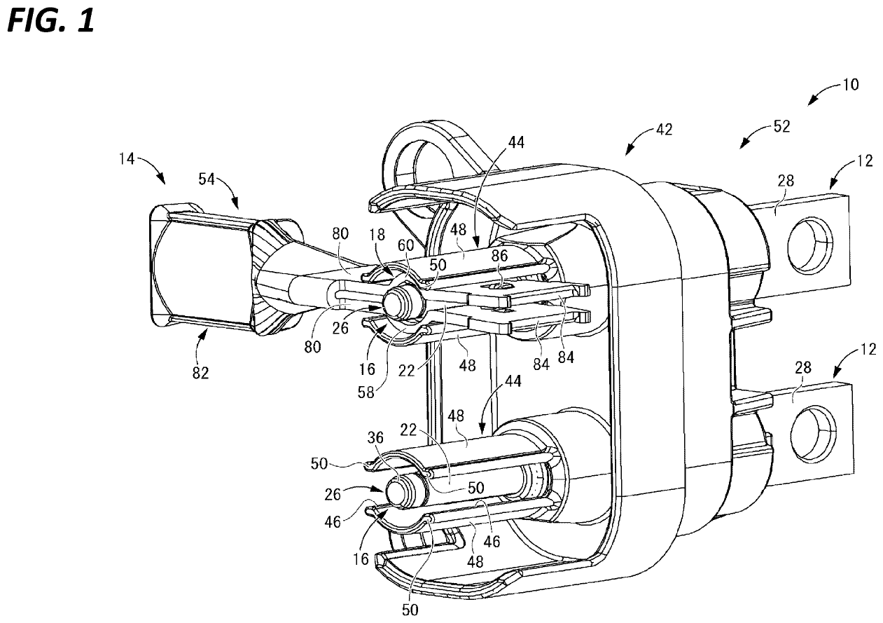

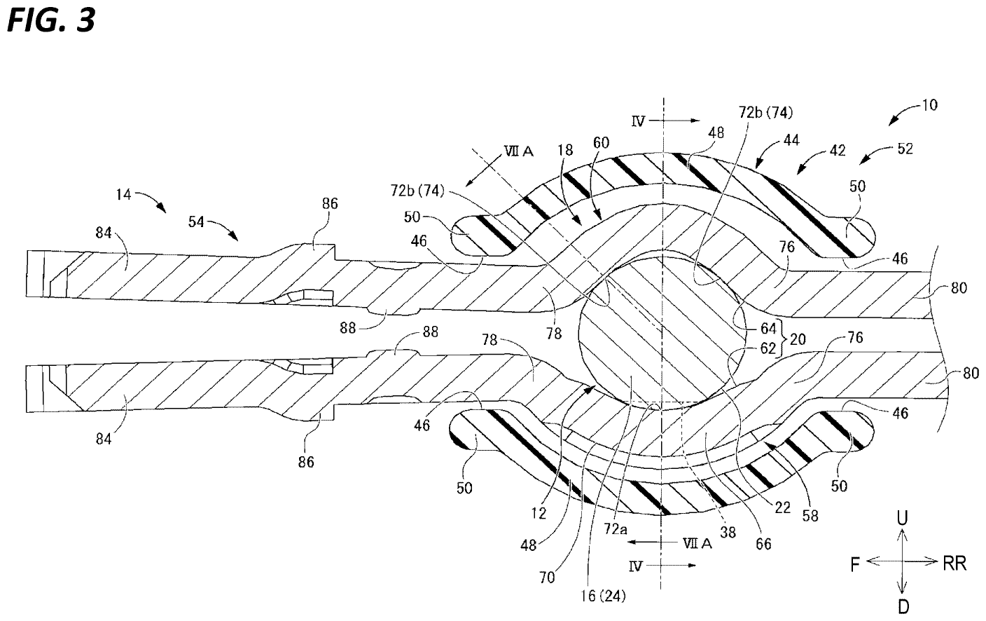

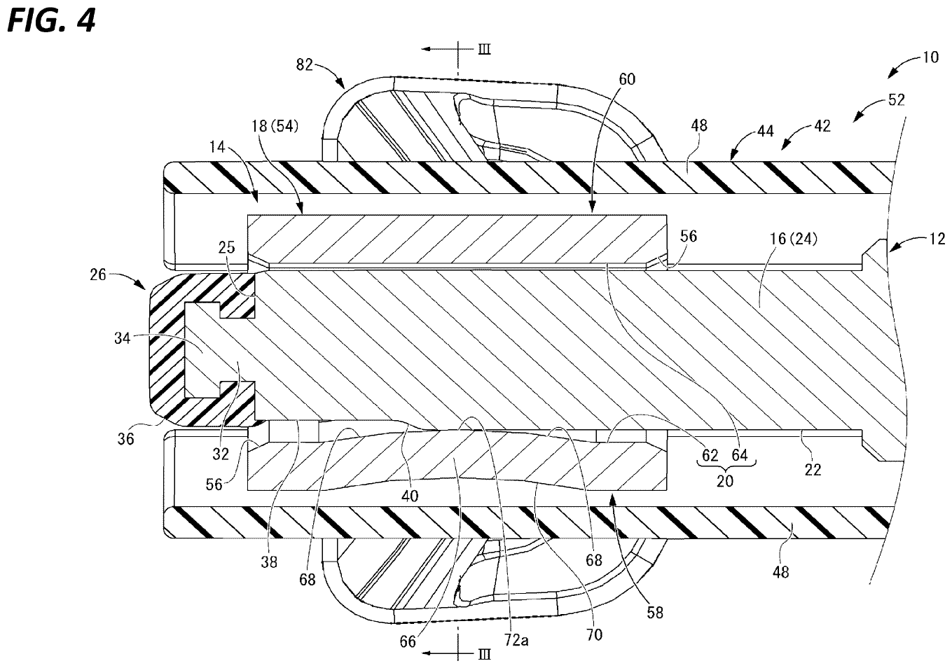

Hereinafter, a terminal unit 10 and a first terminal 12 and a second terminal 14 constituting the terminal unit 10 according to a first embodiment of the present disclosure are described using FIGS. 1 to 7D. The first terminal 12 is provided with a columnar connecting portion 16, and the second terminal 14 is provided with a tubular connecting portion 18 resiliently deformable in a diameter expanding direction. By press-fitting the columnar connecting portion 16 of the first terminal 12 into the tubular connecting portion 18 of the second terminal 14, the columnar connecting portion 16 is assembled with the tubular connecting portion 18. The first and second terminals 12, 14 are conductively connected by bringing the outer peripheral surface of the columnar connecting portion 16 and an inner peripheral surface 20 of the tubular connecting portion 18 into contact with each other. That is, in the first embodiment, the first terminal 12 is a male terminal and the second terminal 14 is a female terminal. Further, a first side contact point 22 is formed by the outer peripheral surface of the first terminal 12 and second side contact points 72a, 72b to be described later are provided on the inner peripheral surface 20 of the tubular connecting portion 18. In the following description, a front side is a left side in FIG. 3, and a rear side is a right side in FIG. 3. An upper side is an upper side in FIG. 3, and a lower side is a lower side in FIG. 3. A left side is a left side in FIG. 4, and a right side is a right side in FIG. 4. Further, for a plurality of identical members, only some members may be denoted by a reference sign and the other members may not be denoted by the reference sign.

### (First Terminal 12)

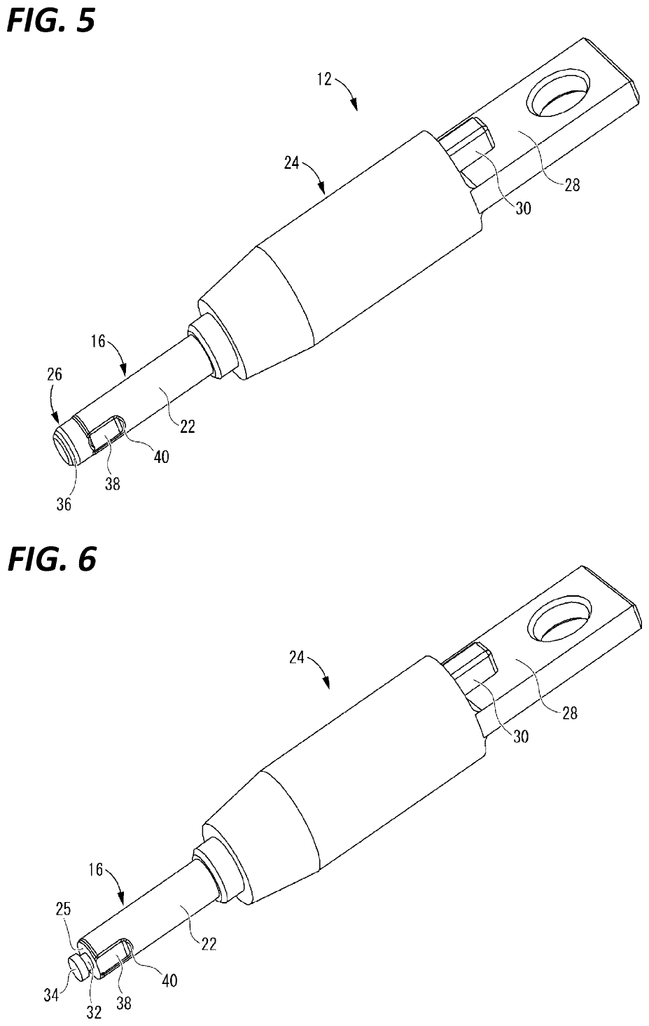

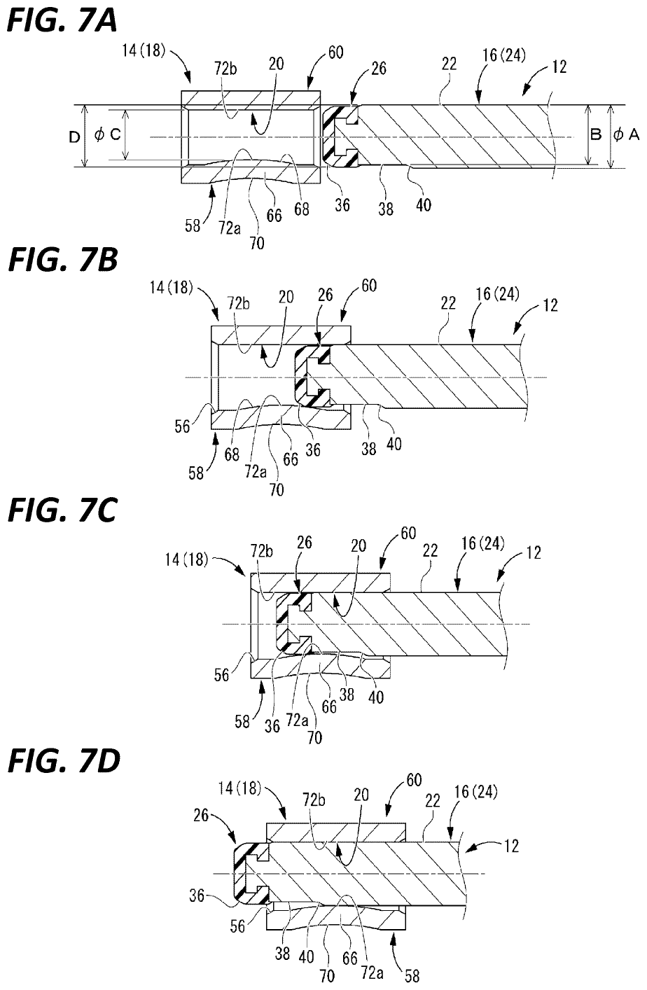

As also shown in FIGS. 5 and 6, the first terminal 12 is provided with the columnar connecting portion 16 having a maximum outer diameter ϕA (see FIG. 7A) on a tip. In the first embodiment, the columnar connecting portion 16 has a substantially true circular cross-sectional shape and an outer diameter thereof is substantially constant at ϕA in parts other than the formation position of a sliding resistance reducing portion (separated facing surface 38) to be described later in an axial direction. The first terminal 12 includes a first terminal fitting 24 made of metal shown in FIG. 6, and the columnar connecting portion 16 is provided on the tip of this first terminal fitting 24. The first terminal 12 is provided with a resin cap 26 for covering a tip surface 25 of the columnar connecting portion 16 in a press-fitting direction (direction from right to left as described later) into the tubular connecting portion 18. That is, the columnar connecting portion 16 is assembled with the columnar connecting portion 18 by being press-fit with the tip surface 25 in the lead.

Note that the shape of a side closer to a base end than the columnar connecting portion 16 is not limited in the first terminal 12, but a flat plate-like portion 28 is provided on a base end part (right end part) of the first terminal 12 and this flat plate-like portion 28 is provided with a circumferential positioning protrusion 30 projecting outward in a plate thickness direction. This circumferential positioning protrusion 30 is fit into an unillustrated recess in a right end part of a first housing 42 to be described later, thereby preventing the rotation of the first terminal 12 about a center axis with respect to the first housing 42. Further, the flat plate-like portion 28 of the first terminal 12 may be fixed to a terminal portion of a device, for example, by a bolt or the like or may be fixed to a wire.

Further, a fixing portion 34, which has a circular cross-section and to which the resin cap 26 is fixed via a small-diameter portion 32, is provided on the tip surface 25 of the first terminal fitting 24, and the resin cap 26 is provided to cover these small-diameter portion 32 and fixing portion 34. The resin cap 26 is provided to ride over the fixing portion 34 in this way, whereby a possibility of the detachment of the resin cap 26 from the columnar connecting portion 16 (first terminal fitting 24) can be reduced.

The resin cap 26 has an electrical insulating property by being made of synthetic resin. In this embodiment, the outer shape of the resin cap 26 has a substantially true circular cross-sectional shape and has a substantially constant outer diameter in the axial direction, and a tapered surface 36 gradually reduced in diameter toward a tip side is provided on a tip part (left end part) of the outer peripheral surface of the resin cap 26. In this way, the outer diameter on the tip of the resin cap 26 is smaller than that of the base end part of the resin cap 26.

Note that a maximum outer diameter of the resin cap 26 is not limited, but is, for example, set substantially equal to or slightly smaller than the maximum outer diameter ¢A of the columnar connecting portion 16. In the first embodiment, the resin cap 26 is formed in such a size that a lower end part of the outer peripheral surface of the resin cap 26 is located slightly below the separated facing surface 38 to be described later. Such a resin cap 26 may be formed separately from the columnar connecting portion 16 and may be assembled with the tip of the columnar connecting portion 16 such as by press-fitting, or may be integrally formed to the columnar connecting portion 16.

Here, the sliding resistance reducing portion extending in the axial direction (lateral direction) from the tip surface 25 toward the outer peripheral surface of the columnar connecting portion 16, which is the first side contact point 22, i.e. toward the base end side, is provided in the tip part of the columnar connecting portion 16. In the first embodiment, the sliding resistance reducing portion is formed by the separated facing surface 38.

### (Sliding Resistance Reducing Portion (Separated Facing Surface 38))

The separated facing surface 38 is provided on the tip part of the outer peripheral surface of the columnar connecting portion 16 and has a predetermined length (lateral dimension). The separated facing surface 38 is provided on a partial circumference and, in the first embodiment, provided in a predetermined circumferential region in a lower part of the columnar connecting portion 16 as also shown in FIG. 3 and the like. The separated facing surface 38 has a substantially flat shape and is located radially inward of the substantially annular outer peripheral surface of the columnar connecting portion 16. That is, a recess recessed in the outer peripheral surface and extending in the axial direction is provided in the tip part of the columnar connecting portion 16, and the separated facing surface 38 is formed by the bottom surface of this recess. In this way, a separation distance B (see FIG. 7A) in the vertical direction between an upper end part of the outer peripheral surface of the columnar connecting portion 16 and the separated facing surface 38 is set smaller than the maximum outer diameter ϕA of the columnar connecting portion 16.

Note that the separated facing surface 38 and the outer peripheral surface of the columnar connecting portion 16 are smoothly continuous, and a curved surface 40 is provided on a peripheral edge part of the separated facing surface 38. Note that since the resin cap 26 is provided to overlap on the tip surface 25 of the columnar connecting portion 16, the curved surface 40 is provided also over the base end of the resin cap 26. By providing such a curved surface 40, the columnar connecting portion 16 is prevented from being caught by the tubular connecting portion 18 due to a step formed by providing the separated facing surface 38 when the columnar connecting portion 16 is press-fit into the tubular connecting portion 18 and removed from the tubular connecting portion 18.

### (First Housing 42)

The first housing 42 has a substantially tubular shape as a whole and includes a tubular cover portion 44 having a through hole extending in the lateral direction, and a pair of cut portions 46, 46 extending in the lateral direction are provided at two positions on both sides in the front-rear direction radially facing each other in the tubular cover portion 44. Each of these cut portions 46 has a predetermined circumferential dimension (width) and is provided substantially over the entire length of the tubular cover portion 44, and the tubular cover portion 44 is divided in a circumferential direction by these cut portions 46. In this way, the tubular cover portion 44 is provided with a pair of curved plate portions 48, 48 facing each other on both sides in the vertical direction. That is, each curved plate portion 48 is provided between the cut portions 46 in the circumferential direction in the tubular cover portion 44 and has a predetermined dimension in the front-rear direction. Further, flat plate portions 50, 50 projecting outward in the front-rear direction are provided on both circumferential end parts of each curved plate portion 48. Each of these flat plate portions 50 is provided substantially over the entire length of each curved plate portion 48.

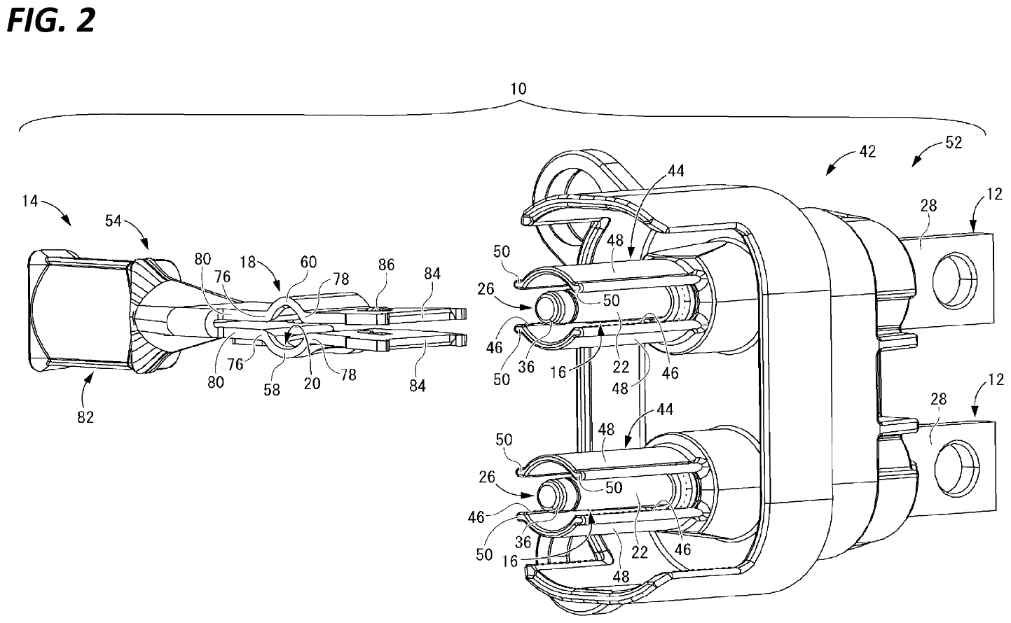

The first terminal 12 is inserted into the through hole of the tubular cover portion 44 in the first housing 42 and the first terminal 12 and the first housing 42 are fixed to each other by press-fitting, locking of recesses and projections, adhesion, welding or the like, whereby a housing-equipped first terminal 52 shown in FIG. 2 and the like is configured. Note that, as described above, an unillustrated recess is provided in a right end part of the first housing 42, and the rotation of the first terminal 12 about a center axis with respect to the first housing 42 is prevented by fitting the circumferential positioning protrusion 30 of the first terminal 12 into the recess. In this way, the separated facing surface 38 is provided below in each first terminal 12 in the housing-equipped first terminal 52. Further, as also shown in FIG. 2, the columnar connecting portion 16 is located at a predetermined radial distance from each curved plate portion 48 on an inner peripheral side of each curved plate portion 48 and the columnar connecting portion 16 is covered by the respective curved plate portions 48 over the entire length in the length direction (lateral direction) in the housing-equipped first terminal 52. In the first embodiment, a pair of the first terminals 12, 12 are assembled with the common first housing 42 and arranged apart from each other in the vertical direction.

### (Second Terminal 14)

The second terminal 14 is configured to include a second terminal fitting 54. This second terminal fitting 54 is, for example, formed by press-working a substantially strip-like metal flat plate into a predetermined shape as a whole. Copper, copper alloy, aluminum, aluminum alloy and the like low in electrical resistance can be adopted as a metal constituting the metal flat plate. The second terminal fitting 54 is provided with the aforementioned tubular connecting portion 18. Further, the second terminal 14 may be configured to include a spring member or the like for biasing a first peripheral wall portion 58 and a second peripheral wall portion 60 to be described later in directions toward each other.

### (Tubular Connecting Portion 18)

The tubular connecting portion 18 has a substantially hollow cylindrical shape as a whole and is open on both sides in the lateral direction. That is, an axial direction of the tubular connecting portion 18 is the lateral direction. Note that, in the second terminal 14 before the first terminal 12 is press-fit, a diameter C (see FIG. 7A) of a virtual circle passing through an arcuate protrusion 66 and each linear contact portion 74 constituting the second side contact points 72a, 72b to be described later is smaller than the outer diameter ¢A of the columnar connecting portion 16 and smaller than a separation distance D (see FIG. 7A) in the vertical direction between an upper end part of the outer peripheral surface of the columnar connecting portion 16 and a lower end part of the resin cap 26. Further, tapered surfaces 56, 56 gradually expanded in diameter toward outer sides in an opening direction are respectively provided on both openings in the tubular connecting portion 18. Note that, since the tubular connecting portion 18 is divided into the first and second peripheral wall portions 58, 60 facing each other in the vertical direction as described later in the first embodiment, the respective tapered surfaces 56 are separately provided on the first and second peripheral wall portions 58, 60 on both sides in the vertical direction.

### (First Peripheral Wall Portion 58 and Second Peripheral Wall Portion 60)

The tubular connecting portion 18 is configured to include the first and second peripheral wall portions 58, 60 arranged to face each other in the vertical direction. In the first embodiment, the first peripheral wall portion 58 is located on a lower side and the second peripheral wall portion 60 is located on an upper side. Each of the first and second peripheral wall portions 58, 60 is a substantially halved tubular body, and the first and second peripheral wall portions 58, 60 respectively have inner peripheral surfaces 62, 64 having an arcuate cross-sectional shape in a longitudinal cross-section of the second terminal 14 shown in FIG. 3 and the like. Accordingly, the inner peripheral surface 20 of the tubular connecting portion 18 is constituted by the both inner peripheral surfaces 62, 64 of the first and second peripheral wall portions 58, 60. As also shown in FIG. 3, when the columnar connecting portion 16 of the first terminal 12 is press-fit into the tubular connecting portion 18 of the second terminal 14, the first side contact point 22 formed by the outer peripheral surface of the columnar connecting portion 16 and the respective second side contact points 72a, 72b provided on the inner peripheral surface 20 (both inner peripheral surfaces 62, 64) of the tubular connecting portion 18 contact each other.

As also shown in FIGS. 3 and 4, the arcuate protrusion 66 projecting radially inward while extending in the circumferential direction is provided in a circumferential central part of the inner peripheral surface 62 of the first peripheral wall portion 58. This arcuate protrusion 66 is provided in a lateral central part of the first peripheral wall portion 58 and projects most radially inward in a lateral center. The arcuate protrusion 66 has a predetermined axial dimension (lateral dimension), which is smaller than the entire lateral length of the first peripheral wall portion 58. Further, as also shown in FIG. 4, both sides in the lateral direction across the lateral center projecting most radially inward on the inner surface of the arcuate protrusion 66 are curved surfaces 68, 68 having a projecting dimension gradually reduced toward a lateral outer side.

Note that, in the first embodiment, the arcuate protrusion 66 is formed by applying press-working to the first peripheral wall portion 58. In this way, a recess 70 open outward (downward) is formed at a position corresponding to the arcuate protrusion 66 on the outer peripheral surface of the first peripheral wall portion 58.

A curvature of the inner surface of the arcuate protrusion 66 is smaller than that of the outer peripheral surface (first side contact point 22) of the columnar connecting portion 16. In this way, when the first and second terminals 12, 14 are fit as shown in FIG. 3 and the like, a circumferential center of the arcuate protrusion 66 contacts the outer peripheral surface (first side contact point 22) of the columnar connecting portion 16. That is, the second side contact point 72a to be held in contact with the first side contact point 22 when the first and second terminals 12, 14 are fit is formed particularly by a top part of the circumferential center on the inner surface of the arcuate protrusion 66.

In the longitudinal cross-section of the second terminal 14 shown in FIG. 3 and the like, a curvature of the inner peripheral surface 64 of the second peripheral wall portion 60 is partially different in the circumferential direction. Specifically, parts where the curvature is smaller than in the circumferential central part are provided at two positions separated toward both circumferential end sides from the circumferential central part on the inner peripheral surface 64. In this way, in the longitudinal cross-section of the second terminal 14 shown in FIG. 3 and the like, the circumferential central part of the inner peripheral surface 64 has an arcuate shape having a substantially constant curvature and parts extending substantially straight are connected to both circumferential ends of the arcuate part. In short, the inner peripheral surface 64 projects more radially inward at the two positions separated toward the both circumferential end sides from the circumferential central part as compared to the case where the inner peripheral surface 64 is a curved surface having a substantially constant curvature.

In the first embodiment, the second peripheral wall portion 60 extends in the lateral direction, which is the axial direction of the tubular connecting portion 18, while having substantially constant inner and outer surface shapes. Thus, as described later, when the columnar connecting portion 16 is press-fit into the tubular connecting portion 18, the inner peripheral surface 64 of the second peripheral wall portion 60 and the outer peripheral surface (first side contact point 22) of the columnar connecting portion 16 contact at the two positions separated toward the both circumferential end sides from the circumferential central part of the inner peripheral surface 64. Further, when the press-fitting of the columnar connecting portion 16 into the tubular connecting portion 18 is completed, the inner peripheral surface of the second peripheral wall portion 60 and the outer peripheral surface (first side contact point 22) of the columnar connecting portion 16 are in contact at the two positions separated toward the both circumferential end sides from the circumferential central part of the inner peripheral surface 64. These second peripheral wall portion 60 and columnar connecting portion 16 are in line contact at the two positions separated toward the both circumferential end sides from the circumferential central part. In the first embodiment, the parts of the second peripheral wall portion 60 having a small curvature of the inner peripheral surface 64, projecting radially inward and to be held in contact with the columnar connecting portion 16 are the linear contact portions 74.

That is, the linear contact portions 74 projecting radially inward while extending in the axial direction of the tubular connecting portion 18 are provided at a plurality of positions (two positions) separated in the circumferential direction on the inner peripheral surface 64 of the second peripheral wall portion 60. In addition to the second side connecting portion 72a of the aforementioned arcuate protrusion 66, the pair of second side contact points 72b, 72b to be held in contact with the first side contact point 22 at the time of fitting the first and second terminals 12, 14 are formed by top parts of these linear contact portions 74. Each second side contact point 72b (each linear contact portion 74) on the side of the second peripheral wall portion 60 linearly extends in the lateral direction. Particularly, in the first embodiment, the second side contact point 72a (circumferential center of the arcuate protrusion 66) on the side of the first peripheral wall portion 58 is arranged between the second side contact points 72b, 72b (pair of linear contact portions 74, 74) on the side of the second peripheral wall portion 60 in the front-rear direction when the first and second peripheral wall portions 58, 60 are projected in a facing direction (viewed in the vertical direction).

### (Second Terminal Fitting 54)

In the second terminal fitting 54, rear end parts of the first and second peripheral wall portions 58, 60 are circumferential end parts facing each other in the vertical direction and respectively serve as first circumferential end parts 76, 76. This pair of first circumferential end parts 76, 76 are facing each other at a predetermined separation distance in the vertical direction. Further, front end parts of the first and second peripheral wall portions 58, 60 are circumferential end parts facing each other in the vertical direction and respectively serve as second circumferential end parts 78, 78. This pair of second circumferential end parts 78, 78 are facing each other at a predetermined separation distance in the vertical direction.

The pair of first circumferential end parts 76, 76 are provided with a pair of base end side plate portions 80, 80 respectively projecting radially outward (rearward) of the tubular connecting portion 18. As described above, the second terminal fitting 54 is formed by press-working the substantially strip-like metal flat plate, and the pair of base end side plate portions 80, 80 are coupled to each other in rear parts of the base end side plate portions 80, 80. In the first embodiment, the pair of base end side plate portions 80, 80 respectively have a substantially rectangular shape when viewed from the vertical direction.

A wire fixing portion 82, to which an unillustrated wire is fixed, is provided behind the base end side plate portions 80, 80. The wire to be fixed to the wire fixing portion 82 is, for example, a coated wire, and a core wire exposed by stripping an insulation coating in an end part of the wire is fixed to the wire fixing portion 82 provided in a rear end part of the second terminal 14 (second terminal fitting 54). Note that a method for fixing the core wire of the wire to the second terminal 14 (second terminal fitting 54) is not limited, but may be crimping using a crimping piece, adhesion, welding or the like. Note that, instead of the wire, the second terminal 14 may be fixed to a terminal portion of a device by a bolt or the like.

The pair of second circumferential end parts 78, 78 are provided with a pair of tip side plate portions 84, 84 respectively projecting radially outward (forward) of the tubular connecting portion 18. The pair of tip side plate portions 84, 84 respectively have a substantially rectangular shape when viewed from the vertical direction and are separated from each other in the vertical direction. That is, in the second terminal 14, the base end side plate portions 80, 80 are coupled to the first and second peripheral wall portions 58, 60 on one side (rear side) in the front-rear direction, and the tip side plate portions 84, 84 are separated from each other and constitute cantilevered free ends on the other side (front side) in the front-rear direction for the first and second peripheral wall portions 58, 60. As a result, the tip side plate portions 84, 84 are resiliently deformable in directions toward and away from each other.

A clip spring serving as an unillustrated spring member for biasing the respective tip side plate portions 84 in the directions toward each other and, consequently, biasing the first and second peripheral wall portions 58, 60 in directions toward each other may be mounted on tip parts (front end parts) of the tip side plate portions 84, 84. A protrusion 86 for fixing, for example, the clip spring is provided to project vertically outward on the outer surface in the vertical direction of each tip side plate portion 84. Further, a stopper portion 88 for hindering mutual contact of the respective tip side plate portions 84, for example, when the clip spring is provided, is provided to project vertically inward on the inner surface in the vertical direction of each tip side plate portion 84.

In the second terminal fitting 54 formed by bending the metal flat plate into such a shape, the inner diameter (diameter of the virtual circle passing through the respective second side contact points 72a, 72b and 72b) ϕC of the tubular connecting portion 18 before the columnar connecting portion 16 is press-fit is smaller than the maximum outer diameter ϕA of the columnar connecting portion 16, smaller than the vertical distance B between the upper end part of the outer peripheral surface of the columnar connecting portion 16 and the separated facing surface 38 and smaller than the vertical distance D (see FIG. 7A) between the upper end part of the outer peripheral surface of the columnar connecting portion 16 and the lower end part of the resin cap 26 as described above.

### (Assembly of Terminal Unit 10)

A model method for assembling the terminal unit 10 by press-fitting the columnar connecting portion 16 of the first terminal 12 into the tubular connecting portion 18 of the second terminal 14 shaped as described above is described using FIGS. 7A to 7D. Note that FIGS. 7A and 7D show stepwise proceeded states of the press-fitting of the columnar connecting portion 16 into the tubular connecting portion 18. FIG. 7A shows a state when the press-fitting is started. FIGS. 7B and 7C show states during the press-fitting. Further, FIG. 7D shows a state when the press-fitting is completed and shows the state of FIGS. 1 to 4 described above in which the terminal unit 10 is assembled.

First, each first terminal 12 is fixed to the first housing 42 to form the housing-equipped first terminal 52. Note that the second terminal 14 is fixed to an unillustrated second housing, and a housing-equipped second terminal may be formed by fixing the second terminal to the second housing. Thereafter, as shown in FIG. 2, the columnar connecting portion 16 of the first terminal 12 and the tubular connecting portion 18 of the second terminal 14 are caused to face each other in the lateral direction and substantially concentrically arranged by aligning center axes thereof. A state where the columnar connecting portion 16 and the tubular connecting portion 18 are substantially concentrically arranged in this way is the state shown in FIG. 7A.

Note that although the second terminal 14 is assembled with the upper one of the two first terminals 12 in FIGS. 1 and 2, the second terminal 14 may be assembled also with the lower first terminal 12 or a female terminal different from the second terminal may be assembled. Further, in the case of assembling the second terminal 14 with the lower first terminal 12, the second terminal 14 assembled with the lower first terminal 12 may be assembled in the same orientation as the second terminal 14 assembled with the upper first terminal (i.e. in such an orientation that the wire fixing portion 82 is provided behind the tubular connecting portion 18 and a wire is connected to a rear end part of the second terminal 14) or may be assembled in an orientation opposite to that of the second terminal 14 assembled with the upper first terminal 12 in the front-rear direction (i.e. in such an orientation that the wire fixing portion 82 is provided in front of the tubular connecting portion 18 and a wire is connected to a front end part of the second terminal 14).

Then, from the state shown in FIG. 7A, the columnar connecting portion 16 is inserted into the tubular connecting portion 18 to achieve the state shown in FIG. 7B. In this state, the columnar connecting portion 16 is inserted into the tubular connecting portion 18 from the side of the resin cap 26. Here, the initial inner diameter QC in the tubular connecting portion 18 is smaller than the separation distance D between the upper end part of the peripheral surface of the columnar connecting portion 16 and the lower end part of the resin cap 26. In this way, in the state shown in FIG. 7B, the arcuate protrusion 66 is in contact with the outer peripheral surface of the resin cap 26 in the lower part of the tubular connecting portion 18 and each linear contact portion 74 is in contact with the outer peripheral surface of the columnar connecting portion 16 in the upper part of the tubular connecting portion 18, whereby the first and second peripheral wall portions 58, 60 of the tubular connecting portion 18 are pushed and expanded toward an outer peripheral side.

Note that, although not shown in FIG. 7B, the first and second peripheral wall portions 58, 60 of the second terminal 14 are inserted in gaps on both sides in the vertical direction between the upper and lower curved plate portions 48 and the columnar connecting portion 16 in this state as also shown in FIG. 1. The pair of tip side plate portions 84, 84 of the second terminal 14 project forward through the cut portion 46 on the front side, and the pair of base end side plate portions 80, 80 of the second terminal 14 project rearward through the cut portion 46 on the rear side. In this way, the respective tip side plate portions 84 and the respective base end side plate portions 80 contact the circumferential end parts (respective flat plate portions 50) of the respective curved plate portions 48, 48, thereby preventing relative rotation of the first and second terminals 12, 14, i.e. relative rotation of the columnar connecting portion 16 and the tubular connecting portion 18 about the center axis of the columnar connecting portion 16. In short, the columnar connecting portion 16 is positioned in the circumferential direction with respect to the tubular connecting portion 18 by inserting and arranging the second terminal 14 in the pair of cut portions 46, 46.

From this state shown in FIG. 7B, the columnar connecting portion 16 is further inserted into the tubular connecting portion 18 to achieve the state shown in FIG. 7C. In the state shown in FIG. 7C, the resin cap 26 has ridden over the circumferential central part (second contact point 72a on the lower side) of the arcuate protrusion 66. Here, the separated facing surface 38 located more radially inward than the outer peripheral surface of the columnar connecting portion 16 is provided in the lower part of the outer peripheral surface of the columnar connecting portion 16. At this point of time, the inner diameter of the tubular connecting portion 18 is equal to the separation distance D in the vertical direction between the upper end part of the outer peripheral surface of the columnar connecting portion 16 and the lower end part of the resin cap 26 and larger than the separation distance B in the vertical direction between the upper end part of the outer peripheral surface of the columnar connecting portion 16 and the separated facing surface. In this way, the second side contact point 72a on the lower side and the separated facing surface 38 are separated in the radial direction (vertical direction) of the tubular connecting portion 18 and facing each other across a gap. As a result, as shown in FIG. 7C, direct sliding contact of the second side contact point 72a on the lower side and the outer peripheral surface of the columnar connecting portion 16 is avoided in a state during the insertion of the columnar connecting portion 16.

Then, from the state shown in FIG. 7C, the columnar connecting portion 16 is further inserted into the tubular connecting portion 18 to achieve an insertion completed state shown in FIG. 7D. In the insertion completed state, the separated facing surface 38 has passed through the circumferential central part of the arcuate protrusion 66 and a part behind the separated facing surface 38 on the outer peripheral surface (first side contact point 22) of the columnar connecting portion 16 is in contact with the circumferential central part (second side contact point 72a on the lower side) of the arcuate protrusion 66. Further, in the upper part of the tubular connecting portion 18, the contact of the respective second side contact points 72b formed by the respective linear contact portions 74 and the outer peripheral surface (first side contact point 22) of the columnar connecting portion 16 is maintained. In this way, the first side contact point 22 in the columnar connecting portion 16 and the respective second side contact points 72a, 72b and 72b in the tubular connecting portion 18 are in contact and the first and second terminals 12, 14 are electrically connected.

Particularly, since the initial inner diameter ϕC of the tubular connecting portion 18 is smaller than the maximum outer diameter ϕA of the columnar connecting portion 16, the tubular connecting portion 18 is pushed and expanded toward the outer peripheral side by the outer peripheral surface of the columnar connecting portion 16 and the first and second peripheral wall portions 58, 60 are resiliently deformed outward in the vertical direction in the insertion completed state of the columnar connecting portion 16. Then, resilient restoring forces due to this resilient deformation are applied as inward biasing forces in the vertical direction to the first and second peripheral wall portions 58, 60 and the first and second peripheral wall portions 58, 60 are pressed into contact with the outer peripheral surface of the columnar connecting portion 16.

That is, direct sliding contact of the outer peripheral surface of the columnar connecting portion 16 and the second side contact point 72a on the lower side is avoided by the sliding resistance reducing portion (separated facing surface 38) until the sliding resistance reducing portion (separated facing surface 38) moves beyond the second side contact point 72a on the lower side in a press-fitting direction of the columnar connecting portion 16 into the tubular connecting portion 18. In this way, the sliding resistance of the columnar connecting portion 16 against the second side contact point 72a on the lower side is reduced. After the sliding resistance reducing portion (separated facing surface 38) moves beyond the second side contact point 72a on the lower side, the outer peripheral surface (first side contact point 22) of the columnar connecting portion 16 is pressed into contact with the respective second side contact points 72a, 72b and 72b. The terminal unit 10 of the first embodiment is completed by an assembly process as described above.

According to the terminal unit 10 of the first embodiment, direct sliding of the second side contact point 72a on the lower side in the tubular connecting portion 18 and the first side contact point 22 (outer peripheral surface of the columnar connecting portion 16) is avoided while the columnar connecting portion 16 is being press-fit into the tubular connecting portion by providing the sliding resistance reducing portion (separated facing surface 38) in the columnar connecting portion 16. In this way, the metal touch of the first side contact point 22 and the second side contact point 72a on the lower side, both made of metal, is avoided, and the scraping of plating provided on the first side contact point 22 and the second side contact point 72a on the lower side is prevented. Further, in a press-fitting completed state of the columnar connecting portion 16 into the tubular connecting portion 18, the first side contact point 22 and the second side contact points 72a, 72b and 72b are pressed into contact, wherefore an electrically conductive state of the first and second terminals 12, 14 is more reliably realized. Note that the outer peripheral surface (first side contact point 22) of the columnar connecting portion 16 and the respective second side contact points 72b on the upper side directly contact and slide against each other during the press-fitting of the columnar connecting portion 16 into the tubular connecting portion 18, but the respective second side contact points 72b (respective linear contact portions 74) on the upper side linearly extend in the axial direction (lateral direction) of the tubular connecting portion 18 and a contact area is large. Thus, a sliding pressure between the first side contact point 22 and each second side contact point 72b on the upper side is relatively small and there is no big problem even if these contact points slide against each other in a state of metal touch.

Particularly, since the sliding resistance reducing portion is formed by the separated facing surface 38 separated from the second side contact point 72a on the lower side in the radial direction in the first embodiment, the sliding of the first side contact point 22 and the second side contact point 72a on the lower side is more reliably avoided and the scraping of plating associated with the metal touch can be more reliably prevented.

The first housing 42 is provided with the respective curved plate portions 48 and the respective cut portions 46 and the second terminal 14 is inserted and arranged in the respective cut portions 46, whereby the columnar connecting portion 16 in the first terminal 12 and the tubular connecting portion 18 in the second terminal 14 are positioned in the circumferential direction via the first housing 42. In this way, the sliding resistance reducing portion (separated facing surface 38) is not deviated from the formation position of the second side contact point 72a on the lower side about the center axis of the columnar connecting portion 16 and a trouble that the second side contact point 72a on the lower side contacts a part other than the sliding resistance reducing portion (separated facing surface 38) on the outer peripheral surface of the columnar connecting portion 16 to scrape plating, for example, during the press-fitting of the columnar connecting portion 16 can be avoided.

### Second Embodiment

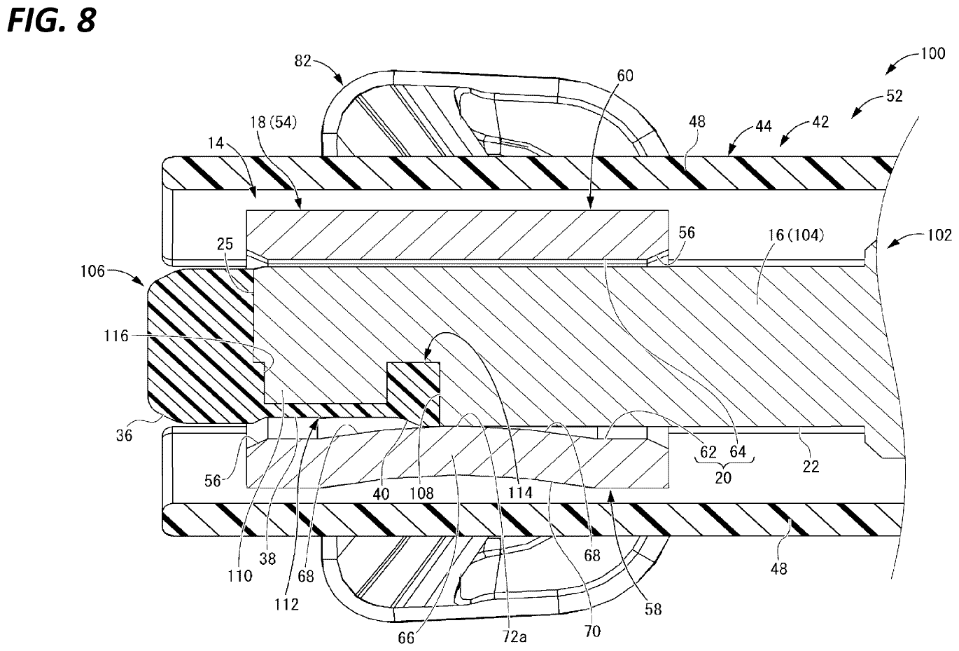

Next, a terminal unit 100 of a second embodiment of the present disclosure and a first terminal 102 constituting the terminal unit 100 are described using FIGS. 8 to 11D. Note that, in the second embodiment, a structure similar to that of the first embodiment can be adopted for a second terminal 14. In the following description, substantially the same members and parts as those of the first embodiment are denoted by the same reference signs as in the first embodiment in figures and not described in detail.

### (First Terminal 102)

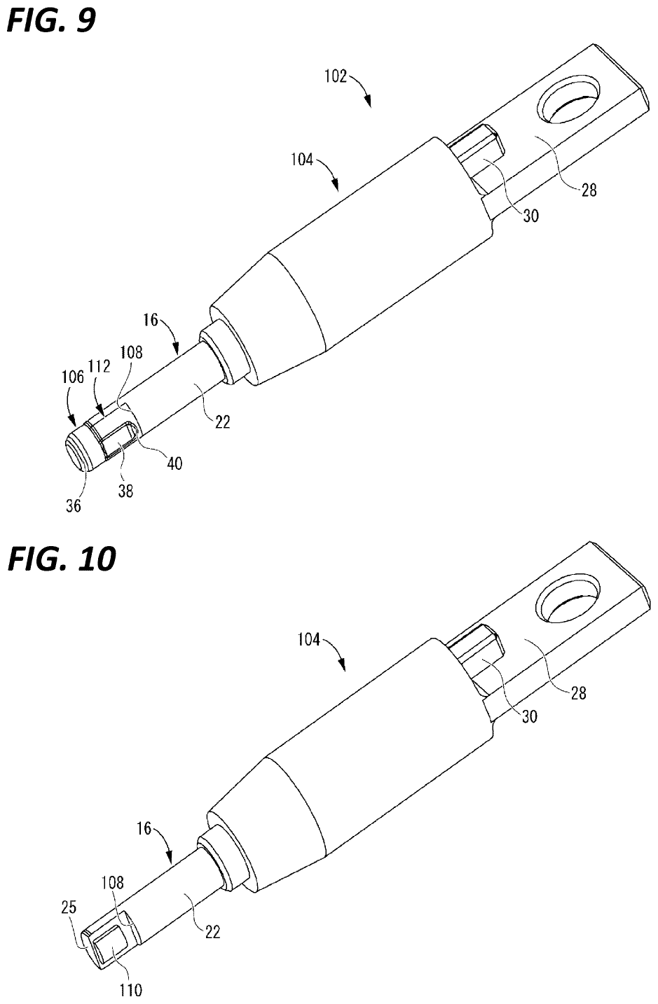

As shown in FIGS. 9 and 10, the first terminal 102 is provided with a first terminal fitting 104 and a resin cap 106 for covering a tip surface 25 of the first terminal fitting 104. A recess 108 is provided by cutting a region over a predetermined axial dimension from the tip surface 25 on a tip part of a columnar connecting portion 16 in the first terminal fitting 104. This recess 108 is formed to have a predetermined circumferential dimension in a lower part of the first terminal fitting 104, and the bottom surface of the recess 108 flatly extends in an axial direction (lateral direction) of the first terminal fitting 104. A projection 110 projecting downward is provided on the bottom surface of this recess 108. The projection 110 has a substantially semicircular cross-section and extends over a predetermined length in the axial direction of the first terminal fitting 104. Note that a first housing 42 similar to that of the first embodiment is assembled with this first terminal 102, and the columnar connecting portion 16 and a tubular connecting portion 18 are positioned in a circumferential direction (about a center axis of the columnar connecting portion 16) via the first housing 42 at the time of inserting the columnar connecting portion 16 into the tubular connecting portion 18.

### (Sliding Resistance Reducing Portion (Resin Outer Peripheral Surface 112))

In a tip part of such a columnar connecting portion 16, the resin cap 106 is mounted to cover the tip surface 25 of the columnar connecting portion 16 and the bottom surface of the recess 108. Such a resin cap 106 integrally includes a resin outer peripheral surface 112 provided to cover the recess 108 and constituting the outer peripheral surface of the columnar connecting portion 16. In short, a region from the tip surface 25 to a first side contact point 22, i.e. a region over a predetermined axial dimension from the tip surface 25 toward a base end side, serves as the resin outer peripheral surface 112 in a lower part of the columnar connecting portion 16. In the second embodiment, a sliding resistance reducing portion is formed by this resin outer peripheral surface 112. Particularly, in the second embodiment, a separated facing surface 38 similar to that of the first embodiment is provided in the resin outer peripheral surface 112. In this way, a sliding amount of a second side contact point 72a on a lower side and the resin outer peripheral surface 112 can be reduced to reduce sliding resistance during the insertion of the columnar connecting portion 16 to be described later into the tubular connecting portion 18.

Note that an engaging hole 116 to be engaged with the projection 110 provided on the columnar connecting portion 16 is provided in a contact surface (i.e. surface overlapping the bottom surface of the recess 108 in the columnar connecting portion 16) of the resin outer peripheral surface 112 with the columnar connecting portion 16, and the resin outer peripheral surface 112 (resin cap 106) is held on the columnar connecting portion 16 by fitting the projection 110 and the engaging hole 116. Note that the resin cap 106 provided with the resin outer peripheral surface 112 may be formed separately from the columnar connecting portion 16 and fixed later as in the first embodiment or may be integrally formed with the columnar connecting portion 16.

### (Assembly of Terminal Unit 100)

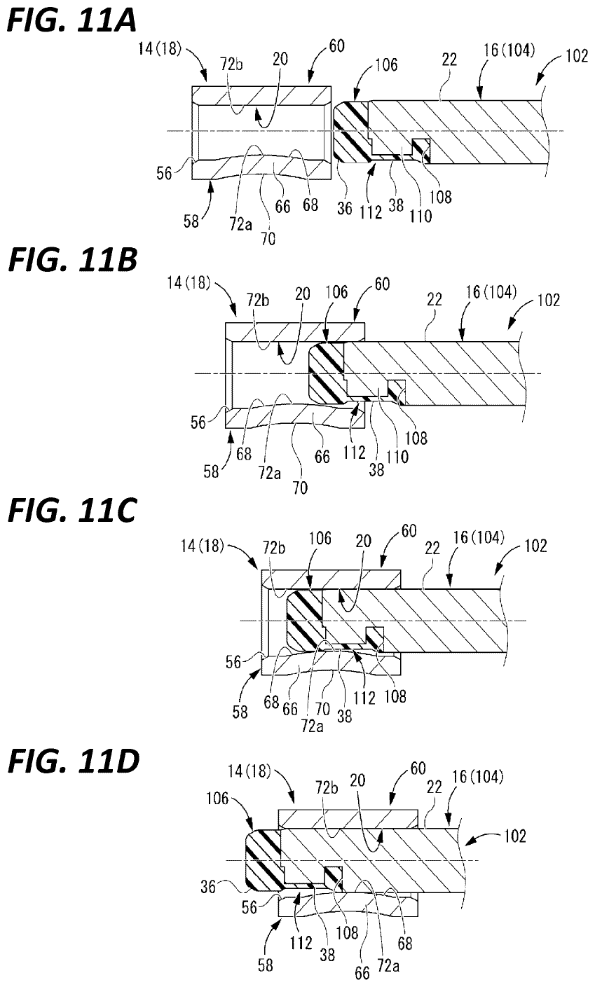

A model method for assembling the terminal unit 100 by press-fitting the columnar connecting portion 16 of the first terminal 102 into the tubular connecting portion 18 of the second terminal 14 shaped as described above is described using FIGS. 11A to 11D. Note that FIGS. 11A and 11D correspond to FIGS. 7A to 7D in the first embodiment. FIG. 11A shows a state when the press-fitting is started. FIGS. 11B and 11C show states during the press-fitting. Further, FIG. 11D shows a state when the press-fitting is completed and shows a state of FIG. 8 in which the terminal unit 100 is assembled.

First, as shown in FIG. 11A, the columnar connecting portion 16 of the first terminal 102 and the tubular connecting portion 18 of the second terminal 14 are caused to face each other in the lateral direction and substantially concentrically arranged by aligning center axes thereof.

Then, from the state shown in FIG. 11A, the columnar connecting portion 16 is inserted into the tubular connecting portion 18 to achieve the state shown in FIG. 11B. In this way, in the state shown in FIG. 11B, an arcuate protrusion 66 is in contact with the outer peripheral surface of the resin cap 100 in a lower part of the tubular connecting portion 18, linear contact portions 74 are in contact with the outer peripheral surface of the columnar connecting portion 16 in an upper part of the tubular connecting portion 18 and first and second peripheral wall portions 58, 60 in the tubular connecting portion 18 are pushed and expanded toward an outer peripheral side (toward both sides in the vertical direction).

From this state shown in FIG. 11B, the columnar connecting portion 16 is further inserted into the tubular connecting portion 18 to achieve the state shown in FIG. 11C. In the state shown in FIG. 11C, the resin cap 106 has ridden over a circumferential central part (second contact point 72a on the lower side) of the arcuate protrusion 66. Also in the second embodiment, the separated facing surface 38 located more radially inward than the outer peripheral surface of the columnar connecting portion 16 is provided in a lower part (resin outer peripheral surface 112) of the outer peripheral surface of the columnar connecting portion 16. As a result, as shown in FIG. 11C, direct sliding contact of the second side contact point 72a on the lower side and the outer peripheral surface (resin outer peripheral surface 112) of the columnar connecting portion 16 is avoided in a state during the insertion of the columnar connecting portion 16. Note that, in the second embodiment, the separated facing surface 38 may not be provided in the resin outer peripheral surface 112 and the circumferential central part (second side contact point 72a on the lower side) and the resin outer peripheral surface 112 may slide against each other when the columnar connecting portion 16 is inserted into the tubular connecting portion 18. In this case, since the outer peripheral surface of the columnar connecting portion 16 and the second side contact point 72 on the lower side, which are made of metal, do not slide against each other while touching each other, a problem of plating scraping does not occur to such an extent as to affect electrical conductivity between the first terminal 102 and the second terminal 14.

Then, from the state shown in FIG. 11C, the columnar connecting portion 16 is further inserted into the tubular connecting portion 18 to achieve an insertion completed state shown in FIG. 11D. In the insertion completed state, the resin outer peripheral surface 112 has passed through the circumferential central part of the arcuate protrusion 66 and a part behind the resin outer peripheral surface 112 on the outer peripheral surface (first side contact point 22) of the columnar connecting portion 16 is in contact with the circumferential central part (second side contact point 72a on the lower side) of the arcuate protrusion 66. Further, in the upper part of the tubular connecting portion 18, the contact of second side contact points 72b formed by the respective linear contact portions 74 and the outer peripheral surface (first side contact point 22) of the columnar connecting portion 16 is maintained. In this way, the first side contact point 22 in the columnar connecting portion 16 and the respective second side contact points 72a, 72b and 72b in the tubular connecting portion 18 are in contact and the first and second terminals 12, 14 are electrically connected.

That is, direct sliding contact of the outer peripheral surface of the columnar connecting portion 16 made of metal and the second side contact point 72a on the lower side is avoided by the sliding resistance reducing portion (resin outer peripheral surface 112) until the sliding resistance reducing portion (resin outer peripheral surface 112) moves beyond the second side contact point 72a on the lower side in a press-fitting direction of the columnar connecting portion 16 into the tubular connecting portion 18. In this way, the sliding resistance of the columnar connecting portion 16 against the second side contact point 72a on the lower side is reduced. After the sliding resistance reducing portion (resin outer peripheral surface 112) moves beyond the second side contact point 72a on the lower side, the outer peripheral surface (first side contact point 22) of the columnar connecting portion 16 is pressed into contact with the respective second side contact points 72a, 72b and 72b as in the first embodiment. The terminal unit 100 of the second embodiment is completed by an assembly process as described above.

The terminal unit 100 in the second embodiment structured as described above can exhibit effects similar to those of the terminal unit 10 in the first embodiment. Particularly, in the second embodiment, a part of the outer peripheral surface of the columnar connecting portion 16 is formed by the resin outer peripheral surface 112. Even if the second side contact point 72a on the lower and the resin outer peripheral surface 112 slide against each other, sliding by metal touch is avoided. Thus, the scraping of plating on the first terminal 102 and/or the second terminal 14 is prevented. Further, since such a resin outer peripheral surface 112 is integrally provided to the resin cap 106, the number of components can be reduced. A possibility of electric shock due to unintended touch with the first terminal 102 can be reduced by providing the resin cap 106. Further, the columnar connecting portion 16 and the resin outer peripheral surface 112 are provided with the projection 110 and the engaging hole 116 to be fit to each other, whereby the detachment of the resin outer peripheral surface 112 (resin cap 106) from the first terminal 102 can be effectively prevented.

### <Modifications

Although the first and second embodiments have been described in detail above as specific examples of the present disclosure, the present disclosure is not limited by this specific description. Modifications, improvements and the like within a range in which the aim of the present disclosure can be achieved are included in the present disclosure. For example, the following modifications of the embodiments are also included in the technical scope of the present disclosure.
(1) The structures of the columnar connecting portion and the tubular connecting portion are not limited to those described in the above embodiments. Although the columnar connecting portion 16 has a substantially true circular cross-sectional shape in the above embodiments, there is no limitation to this and the columnar connecting portion 16 may have, for example, an elliptical, oval or semicircular cross-sectional shape or may have a polygonal cross-sectional shape. Further, the columnar connecting portion needs not necessarily be shaped solid, but may be shaped hollow. Similarly, although the tubular connecting portion 18 has a substantially hollow cylindrical shape in the above embodiments, the tubular connecting portion 18 may have an elliptical cylindrical shape, an oval cylindrical shape, a semicylindrical shape or the like or may have a polygonal tube shape to correspond or not to correspond to the columnar connecting portion.
(2) Although the respective second side contact points 72a, 72b to be held in contact with the first side contact point 22 are provided in the circumferential central part of the arcuate protrusion 66 in the first peripheral wall portion 58 and the respective linear contact portions 74 in the second peripheral wall portion 60 in the above embodiments, there is no limitation to this mode. For example, an arcuate protrusion constituting a second side contact point may be provided in the second peripheral wall portion in addition to the first peripheral wall portion as one mode, or a linear contact portion constituting a second side contact point may be provided also in the first peripheral wall portion in addition to the second peripheral wall portion as another mode. In the case of providing a plurality of second side contact points, a sliding resistance reducing portion for reducing sliding resistance between any one of the second side contact points and the first side contact point during the press-fitting of the columnar connecting portion into the tubular connecting portion may be provided, but the columnar connecting portion is preferably provided with the sliding resistance reducing portion for reducing sliding resistance against the circumferential central part of the arcuate protrusion where sliding resistance is relatively large as in the above embodiments.
(3) As described in the above embodiments, the second terminal may be provided with a spring member for biasing the first and second peripheral wall portions in the directions toward each other. Note that the spring member may be a coil spring or an annular resilient member besides the clip spring illustrated in the above embodiments.
(4) The shape of the first housing is not limited. Although the pair of first terminals 12, 12 are assembled with the common first housing 42 in the above embodiments, one, three or more first terminals may be assembled with the first housing.
(5) The separated facing surface needs not be provided on the resin outer peripheral surface as described in the second embodiment, and the outer peripheral surface of the columnar connecting portion may be an annular surface entirely smoothly continuous, including the resin outer peripheral surface.

### LIST OF REFERENCE NUMERALS

10 terminal unit (first embodiment)
12 first terminal
14 second terminal
16 columnar connecting portion
18 tubular connecting portion
20 inner peripheral surface
22 first side contact point (outer peripheral surface)
24 first terminal fitting
25 tip surface
26 resin cap
28 flat plate-like portion
30 circumferential positioning protrusion
32 small-diameter portion
34 fixing portion
36 tapered surface
38 separated facing surface (sliding resistance reducing portion)
40 curved surface
42 first housing
44 tubular cover portion
46 cut portion
48 curved plate portion
50 flat plate portion
52 housing-equipped first terminal
54 second terminal fitting
56 tapered surface
58 first peripheral wall portion
60 second peripheral wall portion
62, 64 inner peripheral surface
66 arcuate protrusion
68 curved surface
70 recess
72a, 72b second side contact point
74 linear contact portion
76 first circumferential end part
78 second circumferential end part
80 base end side plate portion
82 wire fixing portion
84 tip side plate portion
86 protrusion
88 stopper portion
100 terminal unit (second embodiment)
102 first terminal
104 first terminal fitting
106 resin cap
108 recess
110 projection
112 resin outer peripheral surface (sliding resistance reducing portion)
114 contact surface
116 engaging hole

1. A terminal unit, comprising:
a first terminal including a columnar connecting portion, a first side contact point provided on an outer peripheral surface of the columnar connecting portion and a sliding resistance reducing portion extending from a tip surface of the columnar connecting portion toward the first side contact point; and
a second terminal including a tubular connecting portion resiliently deformable in a diameter expanding direction and a second side contact point provided on an inner peripheral surface of the tubular connecting portion,
the columnar connecting portion being assembled with the tubular connecting portion by being press-fit into the tubular connecting portion with the tip surface in the lead,
the sliding resistance reducing portion avoids direct sliding contact between the outer peripheral surface of the columnar connecting portion and the second side contact point to reduce sliding resistance of the columnar connecting portion against the second side contact point until the sliding resistance reducing portion moves beyond the second side contact point in a press-fitting direction of the columnar connecting portion into the tubular connecting portion, and
the first side contact point being pressed into contact with the second side contact point after the sliding resistance reducing portion moves beyond the second side contact point.

2. The terminal unit of claim 1, wherein a region from the tip surface to the first side contact point has a separated facing surface located radially inward to face the second side contact point across a gap in a radial direction in a circumferential region of the columnar connecting portion overlapping the second side contact point in the press-fitting direction when the columnar connecting portion is concentrically arranged in being press-fit into the tubular connecting portion, and the sliding resistance reducing portion is formed by the separated facing surface.

3. The terminal unit of claim 1, wherein a region from the tip surface to the first side contact point has a resin outer peripheral surface made of a synthetic resin material in a circumferential region of the columnar connecting portion overlapping the second side contact point in the press-fitting direction when the columnar connecting portion is concentrically arranged in being press-fit into the tubular connecting portion, and the sliding resistance reducing portion is formed by the resin outer peripheral surface.

4. The terminal unit of claim 3, comprising a resin cap for covering the tip surface of the columnar connecting portion, the resin outer peripheral surface being integrally provided to the resin cap.

5. The terminal unit of claim 3, wherein a contact surface of the resin outer peripheral surface with the columnar connecting portion includes an engaging hole to be engaged with a projection provided on the columnar connecting portion, and the resin outer peripheral surface is held on the columnar connecting portion by fitting the projection into the engaging hole.

6. The terminal unit of claim 1, further comprising a first housing for accommodating the first terminal, wherein:
the first housing includes a tubular cover portion separated and arranged radially outwardly of the columnar connecting portion,
the tubular cover portion includes a pair of cut portions provided at two positions facing each other in a radial direction of the tubular cover portion, and
the columnar connecting portion of the first terminal is positioned in a circumferential direction in the tubular connecting portion of the second terminal by inserting and arranging the second terminal in the pair of cut portions.

7. A first terminal to be assembled with a second terminal including a tubular connecting portion resiliently deformable in a diameter expanding direction and a second side contact point provided on an inner peripheral surface of the tubular connecting portion,
the first terminal constituting the terminal unit of claim 1.
